(19) United States
(12) Patent Application Publication
(10) Pub. No.: US 2012/0303966 A1
(43) Pub. Date: Nov. 29, 2012

(54) METHOD OF ASSIGNING A SECRET TO A SECURITY TOKEN, A METHOD OF OPERATING A SECURITY TOKEN, STORAGE MEDIUM AND SECURITY TOKEN

(75) Inventor: Thomas Hübner, Paderborn (DE)

(73) Assignee: MORPHO CARDS GMBH, Flintbek (DE)

(21) Appl. No.: 13/504,932

(22) PCT Filed: Nov. 8, 2010
(86) PCT No.: PCT/EP2010/067002

§ 371 Date: Aug. 13, 2012

(30) Foreign Application Priority Data
Nov. 12, 2009 (EP) 09175755.9

(51) Int. Cl. H04L 9/32

(52) U.S. Cl. 713/186

(57) ABSTRACT

A method of assigning a secret to a security token (100) comprising:
receiving first biometrical data (108) of a biometrical feature of a person by the security token,
storing the first biometrical data in the security token,
storing the unencrypted secret in the security token,
biometrically encrypting the secret using the first biometrical data by the security token,
storing the encrypted secret in the security token,
erasing the unencrypted secret and the first biometrical data from the security token.

### FIELD OF THE INVENTION

The present invention relates to the field of security tokens, and more particularly to securely assigning a secret to a security token.

### BACKGROUND AND RELATED ART

Security tokens are as such known from the prior art. Typically a secret personal identification number (PIN) is stored in a security token for a user's authentication vis-à-vis the security token. For the purpose of authentication the user has to enter the PIN into the security token which determines whether the stored PIN and the entered PIN are matching.

Further, security tokens for generating a digital signature are known. A security tokens for generating a digital signature stores a private key of a cryptographic key pair of a user. The secrecy of the private key stored in the security token can be preserved by hardware measures such that when the hardware token is opened, the memory that stores the private key is unavoidably destroyed.

WO 00/36566 A1 relates to a biometric identification mechanism that preserves the integrity of the biometric information. A user's private key is stored in a token in encrypted form. The encryption of the user's private key is based upon a biometric encryption key corresponding to the authorized user.

WO 2009/009788 A1 relates to an identity authentication and secured access system, component and method. At least one credential issued to one of the users is used, wherein the credential includes a security token comprising data encrypted by encryption software with a cryptographic algorithm and encrypted based on a biometric key that is generated from a biometric identifier of the user.

WO 03/100730 A1 relates to a method for generating secure information using biometric information, wherein the method comprises the steps of receiving scan data relating to a person securing data, generating a random cryptographic key, performing a reversible operation on the biometric scan data and said random key to create a template and storing the template.

U.S. Pat. No. 7,526,653 B2 relates to a method wherein a private or secret key is encrypted with data obtained from a biometric feature of the owner of the private key. The encryption achieves a guarantee to the effect that the person who has given his digital signature with the aid of the signature key is in fact the rightful owner.

WO 2008/010773 relates to a method for generating a cryptographic key from biometric data, wherein the method comprises the steps of acquiring a subject's biometric image and extracting characteristic features there from in the form of vector sets, wherein the method further comprises randomly generating a key and applying a mathematical transformation to selected vector sets to encrypt said key, including using a threshold scheme and polynomial functions in a mixture with randomly generated fake vector sets to produce randomly permutated set of elements of the key. Then, a union of the vector sets of the new and fake biometric data with randomly permutated set elements of the key is constructed, which then forms a locked template from the union of values.

U.S. 2008/013804 A1 relates to a method and apparatus for authenticating a fingerprint by hiding minutiae, securely storing information on the fingerprint and authenticating the information on the fingerprint in order to prevent the information on the fingerprint from being reused by an attacker who accesses the information of the fingerprint that is stored in a storage unit.

Directly using biometric features for encrypting data is highly problematic since fingerprints of an individual are unique to that individual and cannot be changed in case for example the individual's fingerprints are compromised by an unauthorized person. Additionally introducing a user's private key which may be changed as often as required and which is encrypted each time with the biometric encryption data provided by the user permits to provide data encryption and decryption capabilities at a sufficiently high level.

However, this security level can only be assured in case the security token used to provide data encryption and decryption capabilities is not lost or stolen. By for example stealing the security token and using common possibilities to obtain information on the user's fingerprints, it is easily possible to misuse the security token by entering said fingerprints to the security token and perform unauthorized data encryption and decryption processes.

The invention aims to provide an improved method of assigning a secret to a security token, a method of operating a security token for performing a cryptographic operation, a storage medium and a security token.

### SUMMARY OF THE INVENTION

The present invention provides a method of assigning a secret to a security token as claimed in the independent claim 1, a method of operating a security token for performing a cryptographic operation as claimed in claim 7, a storage medium storing executable instructions as claimed in claim 11 and a security token as claimed in the independent claim 12. Embodiments of the invention are given in the dependent claims.

In accordance with embodiments of the invention there is provided a method of assigning a secret to a security token comprising receiving first biometrical data of a biometrical feature of a person by the security token, storing the first biometrical data in the security token, storing the unencrypted secret in the security token, biometrically encrypting the secret using the first biometrical data by the security token, storing the encrypted secret in the security token, and erasing the unencrypted secret and the first biometrical data from the security token.

A ‘security token’ as understood herein encompasses any portable physical device that includes a cryptographic function, such as for the purposes of authentication, verification, encryption, decryption or generating a digital signature. Such physical devices include hardware tokens, authentication tokens, USB tokens, in particular USB sticks, chip cards, integrated circuit cards, smart cards, subscriber identity module (SIM) cards, in particular USIM cards, identity documents having an integrated electronic circuit, and RFID tags.

The term ‘biometrical data’ as used herein may refer to the data delivered by a biometrical sensor, such as a fingerprint sensor or an optical sensor, as a result of biometrical data acquisition, or to the result of processing of biometrical raw data that is delivered by such a biometrical sensor. For example the processing performed by the security token using the biometrical raw data may encompass rounding and/or a projection of the biometrical raw data onto a predefined finite body.

The term ‘biometric encryption’ as used herein encompasses any encryption method that uses biometrical data or data that is derived from biometrical data as input information for a given encryption algorithm. For example, the biometrical data may be used as a key for performing the encryption of the secret or a key is derived from the biometrical data which is then used by the encryption algorithm to encrypt the secret.

In accordance with embodiments of the invention the biometrical data is fingerprint data, iris scan data, voice data, or facial biometrical data. The biometrical data can be acquired by means of an external sensor, such as a fingerprint sensor or a camera, that is directly or indirectly coupled to the security token or by a sensor that is integrated into the security token.

The secret to be assigned to the security token can be generated by the security token itself, such as by means of a random number generator, or it can be externally selected, such as by a user, and entered into the security token via a communication interface of the security token.

Embodiments of the present invention are particularly advantageous as the unencrypted secret is not permanently stored in the security token or elsewhere. After encryption the unencrypted secret is erased as well as the first biometrical data that was used for performing the biometrical encryption operation. As a result only the biometrically encrypted secret is stored in non-volatile memory of the security token. The only way to decrypt the secret is to acquire biometrical data of the same biometrical feature of the same person that was used for the encryption providing an utmost degree of security as regards protection of the secret.

Further, in accordance with the invention a hash value of the unencrypted secret is generated by the security token and output for use as a so called pseudo identity (PI) by the person. The PI can be used for authentication purposes vis-à-vis the security token. In other words, the PI can be used as an additional security measure to enable a functionality of the security token.

In a practical example, the generation of the hash value may be designed in such a manner that the resulting PI is for example a combination of four digital numbers like ‘1234’. Thus, these digital numbers can be used in a well known manner as a PIN to authenticate access to security functions of the token. In other words, usage of the security token requires both, the provision of biometric data, as well as the user PIN, wherein usage of the cryptographic functions of the security token is only enabled in case a user is able to provide both, namely the biometric data and the hash value of the unencrypted secret, i.e. the PIN.

The present invention enables a user to arbitrarily change the secret of the security token, wherein with every new change of the secret it is ensured that the personal identifier required to use the security token is also changed. Thus, the security of a respective security token is drastically enhanced. Even though the security token may be lost or stolen and even in case the user's biometric data is publically available, an unauthorized person is still unable to use the token since the person does not know the PI.

In accordance with an embodiment of the invention, the security token has volatile storage, such as the random access memory of its processor, and non-volatile memory. The first biometrical data and the secret are temporarily stored in the volatile storage and the encrypted secret is stored in the non-volatile storage. Assuming that the security token does not have an integrated power supply as is typically the case for smart cards, removing the security token from some external device that provides the power supply, such as a chip card reader, automatically erases the biometrical data and the unencrypted secret stored in the volatile storage means.

In accordance with an embodiment of the invention the first biometrical data and/or the secret are securely erased from the volatile memory while the power supply is still available. This can be implemented by execution of a program module that executes a respective routine for securely erasing the first biometrical data and/or the secret from a RAM of the security token.

In accordance with an embodiment of the invention the biometrical encryption of the secret comprises correction encoding of the unencrypted secret.

The term ‘error correction encoding’ as understood herein encompasses any encoding of the secret that allows error detection and correction, in particular by adding redundant data to the secret, such as by forward error correction (FEC) using convolutional or block codes.

An XOR operation is performed on the error correction encoded secret and the first biometrical data to provide the biometrically encrypted secret. The biometrically encrypted secret is stored in non-volatile memory of the security token for later use in a cryptographic operation, such as for the purposes of authentication of a user or performing another cryptographic operation, in particular an encoding or decoding operation or the generation of a digital signature.

For decrypting the biometrically encrypted secret second biometrical data is acquired of the same biometrical feature of the same person from which the first biometrical data was acquired. The second biometrical data typically is not identical to the first biometrical data due to inaccuracies of the acquisition process of the biometrical data, such as due to inaccuracies of the biometrical sensor that is used for the acquisition, inaccuracies regarding the positioning of the biometrical feature relative to the sensor and/or rounding errors of the algorithm that is used to transform the biometrical raw data delivered by the biometrical sensor into the biometrical data. Due to the error correction encoding of the secret the correct secret can be recovered from the biometrically encrypted secret even if the second biometrical data is not exactly the same as the first biometrical data. If the second biometrical data is not identical to the first biometrical data as it is typically the case, the result of the XOR operation performed on the biometrically encrypted secret and the second biometrical data provides a codeword that contains errors. By error correction decoding of the codeword the correct secret is still recovered.

In accordance with an embodiment of the invention a polynom p is used for biometrically encoding the secret, such as

p(x)=b₀+b₁x+b₂x²+b₃x³+ . . . +bₖ₋₁x^{k-1}

For encrypting a secret having a number k of digits the polynom p having grade k−1 is used as the coefficients of the polynom p are determined by the digits of the secret to be encoded, i.e. the secret being (b₀, b₁, . . . , bₖ₋₁).

The first biometrical data is interpreted to be the x-coordinates of points that are located on the polynom p that is determined by the secret, such as first biometrical data A=(x₁, x₂, . . . , xₜ), where t is the number of values contained in the feature set A that constitutes the first biometrical data. Preferably t is greater than k for adding redundancy.

Using the x-coordinates provided by the feature set A the number of t points that are located on the polynom p are calculated. These points on the polynom p that are determined by the x-coordinates given by the feature set A are referred to as ‘real points’ in the following, i.e. P₁=(x₁, p (x₁)), P₂=(x₂, p (x₂)), . . . , Pₜ=(xₜ, p (xₜ)).

The number of randomly selected points that are not located on the polynom p is combined with the real points. These randomly selected points that are not located on the polynom p are referred to as ‘stray points’ in the following. For obtaining a total number of r points a number of r−t stray points is added to the set of real points. The set union, which is the union of the set of real points and the set of stray points, constitutes the biometrically encrypted secret wherein no information is stored whether a given point is a real point or a stray point in order to ‘disguise’ the presence of the real points within the set union. Hence, the real points cannot be identified in the set union of the r points by a third party attack. The r points are stored in non-volatile memory of the security token for later use.

In accordance with an embodiment of the invention the set union is provided in the form of an unordered list that contains data being indicative of the real points and the stray points such as in random order.

For decryption of the biometrically encrypted secret that is represented by the set union, the second biometrical data is acquired. The second biometrical data is used to identify at least a subset of the real points within the set union. For example, if an x coordinate given by a value the feature set A′ of the second biometrical data matches an x coordinate of one of the r points of the set union that point is considered to be a real point. It is important to note that not all of the real points contained in the set of r points need to be identified this way due to the redundancy that has been added in the encoding operation. Hence, the second biometrical data does not need to be exactly identical to the first biometrical data for obtaining a correctly decoded secret.

From the t values contained in the feature set A′ only k values need to match one of the x-coordinates of the r points for identification of k real points. As the k real points unequivocally determine the polynom p, the coefficients b₀, b₁, . . . , bₖ₋₁ of the polynom p can be obtained by calculation, such as by resolution of an equation system given by the identified real points. Using Reed Solomon decoding the correct polynom p can even be recovered if some stray points in addition to the real points are erroneously selected from the set of r points using the x-coordinates provided by the feature set A′.

In accordance with an embodiment of the invention the encrypted secret can be stored in a template.

Embodiments are the invention are particularly advantageous as the encrypted secret can be generated by the security token itself, such as by so called on-card generation, without a need to enter the secret. For example, the secret is provided by a random number generator of the security token. This has the advantage that no external storage of the secret needs to occur and no transmission of the secret from an external entity, such as a personal computer or a chip card reader, to the security token that would imply the risk of eavesdropping on the transmission of the secret. Furthermore, embodiments of the invention are advantageous as the personal computer or a chip card reader does not need to be a trusted entity which is due to the fact that no critical data needs to be communicated from the security token to such an external entity. Moreover, no critical data will be even temporarily generated outside the token (e.g. in the card reader, terminal or PC).

Alternatively, the biometrically encrypted secret can be generated by an external computer system using the first biometrical data. The biometrically encrypted secret is stored in the security token such as by using a personalization technique. As a further alternative the biometrically encrypted secret is outputted by the security token via an external interface, such as for use a one-time password or as a cryptographic key.

Embodiments of the invention are particularly advantageous because the encrypted secret does not need to be output by the security token for performing a cryptographic operation such as for the purpose of verification/authentication, decryption, encryption or the generation of a digital signature. Both the decryption of the secret and the performance of the cryptographic operation can be performed by the security token itself such that no sensitive data needs to be output from the security token for the performance of such an operation; any critical data that is temporarily available due to the performance of the cryptographic operation, such as the decrypted secret, the biometrical data, the selection of real points, the hash value constituting the pseudo identity or the like can be erased after the performance of the cryptographic operation has been completed. Such erasure may occur automatically if the security token has no integrated power supply, i.e. no battery, and if the critical data except the encrypted secret is stored in volatile memory such that the critical data is erased automatically when the security token is removed from some external device that provides the power supply. In accordance with an embodiment of the invention the first biometrical data and/or the secret are securely erased from the volatile memory while the power supply is still available. This can be implemented by execution of a program module that executes a respective routine for securely erasing the first biometrical data and/or the secret from a RAM of the security token.

### BRIEF DESCRIPTION OF THE DRAWINGS

In the following preferred embodiments of the invention will be described in greater detail by way of example only making reference to the drawings in which:

FIG. 1 shows a block diagram of an embodiment of a security token being illustrative of encrypting a secret,

FIG. 2 is a block diagram of the embodiment of the security token of FIG. 1, being illustrative of decrypting the secret,

FIG. 3 is a flow chart being illustrative of an embodiment of a method of the invention of assigning a secret to a security token,

FIG. 4 is a flow chart being illustrative of an embodiment of a method of the invention of operating a security token for performing a cryptographic operation using the encrypted secret that has been assigned to the security token by the performance of the method of FIG. 3,

FIG. 5 is a block diagram of an embodiment of a security token of the invention being illustrative of encrypting the secret,

FIG. 6 is a flow chart being illustrative of an embodiment of a method of the invention of operating a security token for performing a cryptographic operation using the encrypted secret that has been assigned to the security token by the performance of the method of FIG. 5,

FIG. 7 is a flow chart of a method of assigning the secret to a security token in accordance with an embodiment of the invention,

FIG. 8 is a flow chart being illustrative of an embodiment of a method of the invention of operating a security token for performing a cryptographic operation using the encrypted secret that has been assigned to the security token by the performance of the method of FIG. 7.

### DETAILED DESCRIPTION

In the following detailed description like elements of the various embodiments are designated by identical reference numerals.

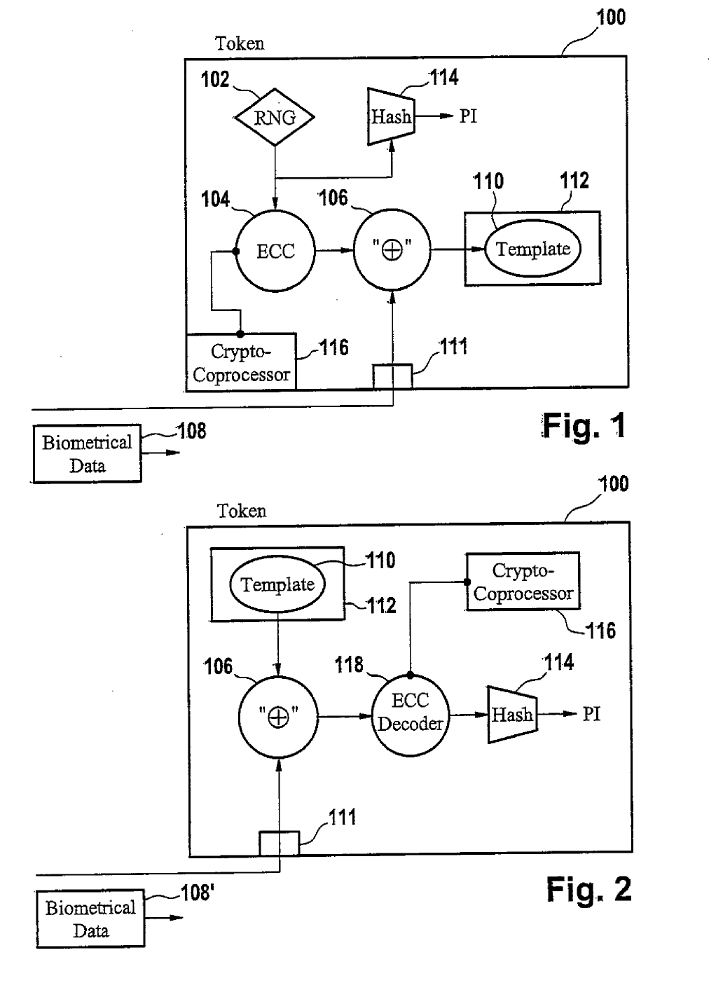

FIG. 1 shows a security token 100, such as a smart card. The security token 100 has an integrated random number generator (RNG) 102 that can generate a random number constituting the secret to be assigned to the security token. The random number generator 102 can be implemented as a pseudo random number generator or as a true physical random number generator, for example by a noise source or a binary symmetric source. In particular, the random number generator 102 can be implemented by software and/or by hardware, such as by means of a shift register with feedback, and/or by a program module that is executed by a processor of the security token 100.

The security token 100 has a module 104 for error correction encoding (ECC). The secret provided by the random number generator 102 is entered into the module 104 for error correction encoding of the secret. The module 104 may be implemented by dedicated logical circuitry or by a program module that is executed by the processor of the security token 100.

Alternatively, some the functionalities of the module 104 are implemented by a program module and other functionalities of the module 104 are implemented by dedicated logical circuitry, such as by logical circuitry of a crypto coprocessor 116. For example, the crypto coprocessor 116 may include logical circuitry for providing shift functions, polynom arithmetic functions such as for Reed-Solomon decoding. Such functions can be called by the program module such that the number of time consuming calculations that need to be implemented in software can be reduced.

The security token 100 has a logic component 106 for receiving the error corrected encoded secret from the module 104 and of first biometrical data 108 via a communication interface 111. In accordance with an embodiment of the invention, the logic component 106 can be implemented by means of the crypto coprocessor 116.

In one implementation the biometrical data 108 is acquired by an external sensor, such as a biometric sensor that is coupled to a personal computer or to an external reading device for the security token 100. The externally acquired biometrical raw data is pre-processed such as by the personal computer or the reading device, for example by rounding the biometrical raw data and/or by performing another transformation on the biometrical raw data, such as projecting the biometrical raw data. The resultant biometrical data 108 is then transmitted to the security token 100 and received by the security token 100 by means of its communication interface 111. The communication interface 111 of the security token 100 can be adapted for contact or contactless communication. For example, the communication interface 111 of the security token 100 is a contact or contactless chip card interface, an RFID interface or the like.

In another implementation the security token 100 has an integrated biometric sensor such that the acquisition of the biometric raw data and any pre-processing of the biometric raw data to provide the biometric data 108 is performed by the security token 100 itself.

The logic component 106 performs an XOR operation on the error correction encoded secret received from the module 104 and on the biometric data 108 which provides the template 110 that contains the resultant encrypted secret. The template 110 is stored in non-volatile memory 112 of the security token 100.

The logic component 106 may be implemented by dedicated logic circuitry or by a program module that is executed by the processor of the security token 100.

The security token 100 may comprise a logic component 114 that receives the unencrypted secret from the random number generator 102. The logic component 114 applies a given hashing function onto the secret and outputs a hash value of the secret that can be used as a PI. The PI can be outputted via the communication interface 111 of the security token 100 for external storage. As an alternative or in addition, the PI is stored in non-volatile memory of the security token 100 for later reference.

The logic component 114 can be implemented by dedicated logical circuitry or by a program module that is executed by the processor of the security token 100.

It is to be noted that the random number generator 102, the module 104, the logic component 106 and the logic component 114 can be provided by a single processor of the security token 100 that executes respective program instructions. The security token 100 may comprise an additional processor, i.e. crypto coprocessor 116, that implements some or all of these cryptographic functionalities, especially the error correction encoding and/or the transformation of the biometrical raw data to the biometrical data 108.

The secret provided by the random number generator 102, the error correction encoded secret provided by the module 104, the biometrical data 108 and the biometrical raw data, if applicable, as well as the PI are only temporarily stored in the security token 100 such as in a random access memory of the processor or the crypto coprocessor 116 of the security token 100. After the template 110 has been stored in the non-volatile memory 112 and after the PI has been outputted, if applicable, these critical data values are erased from the random access memory. However, for some applications it is preferred to store the PI in non-volatile memory rather than to erase it.

FIG. 2 shows the security token 100 illustrating decryption of the encrypted secret contained in the template 110. The security token 100 has a module 118 for error correction decoding of the error correction coding performed by the module 104 shown in FIG. 1. The module 118 may be implemented by dedicated logic circuitry or by a program module that is executed by the processor or the crypto coprocessor 116 of the security token 100.

Alternatively, some the functionalities of the module 118 are implemented by a program module and other functionalities of the module 118 are implemented by dedicated logical circuitry, such as by logical circuitry of a crypto coprocessor 116. For example, the crypto coprocessor 116 may include logical circuitry for providing shift functions, polynom arithmetic functions such as for Reed-Solomon decoding. Such functions can be called by the program module such that the number of time consuming calculations that need to be implemented in software can be reduced.

For decryption of the secret contained in the template 110 biometrical data acquisition is performed of the biometrical feature of the same person from which the biometrical data 108 had been obtained. Due to inaccuracies of the acquisition process the resultant second biometrical data 108′ typically is not exactly identical to the original biometrical data 108. For performing the decryption operation the biometrical data 108′ and the encrypted secret contained in the template 110 are XORed by the logic component 106 and the resultant codeword is then error correction decoded by the module 118 which provides the correct secret. The secret which is thus recovered can then be used by the security token 100, such as by the crypto coprocessor 116, for performing a cryptographic operation such as for the purposes of authentication, decryption, encryption or generating a digital signature, using the secret as a cryptographic key.

For example, the person from which the biometrical feature has been obtained needs to enter its PI into the security token 100. The security token 100 compares the PI received via its communication interface 111 to the PI delivered by the logic component 114, i.e. the hash value of the secret. If the received PI and the PI provided by the logic component 114 are identical, authentication of the person is successful such that the functionality of the security token 100 is enabled. For example, after successful authentication of the person the generation of a digital signature is enabled by the security token 100.

FIG. 3 is a flow chart illustrating an embodiment of assigning a secret to a security token.

In step 200 first biometrical data A is received by the security token either via an external communication interface (cf. communication interface 111 of FIGS. 1 and 2) or internally from an integrated biometrical sensor of the security token. In step 202 a secret B is defined. For example, the person from which the biometrical data A has been acquired may select the secret B and enter the secret B through the external communication interface into the security token. Alternatively, the secret B can be determined on the occasion of a personalization of the security token and entered into the security token via the external communication interface. Hence, the secret B can be determined outside the security token. Alternatively, the secret B is determined by the security token itself, such as by generating a random number using its internal random number generator (cf. random number generated 102 of FIG. 1).

In step 204 an error correction encoding is performed on the secret B to provide the encoded secret b. In step 206 an XOR operation is performed on the error correction encoded secret b and the biometrical data A, such as by performing the XOR operation bitwise which provides the protected template T. In step 208 T is stored in non-volatile memory of the security token and in step 210 the biometrical data A and the secret B are erased from the security token such that only the template T remains within the security token as a result of the performance of the assignment of the secret to the security token. It is important to note that the secret B is not stored in any form on the security token but only the template T from which the secret B cannot be recovered unless the biometrical data is acquired from the person. Hence, the secret B is assigned to the security token without storing the secret B inside the security token or elsewhere.

In accordance with an embodiment of the invention, a hash value of the secret B is generated and output by the security token, such as via its interface 111, in step 202. The hash value is stored in non-volatile memory of the security token.

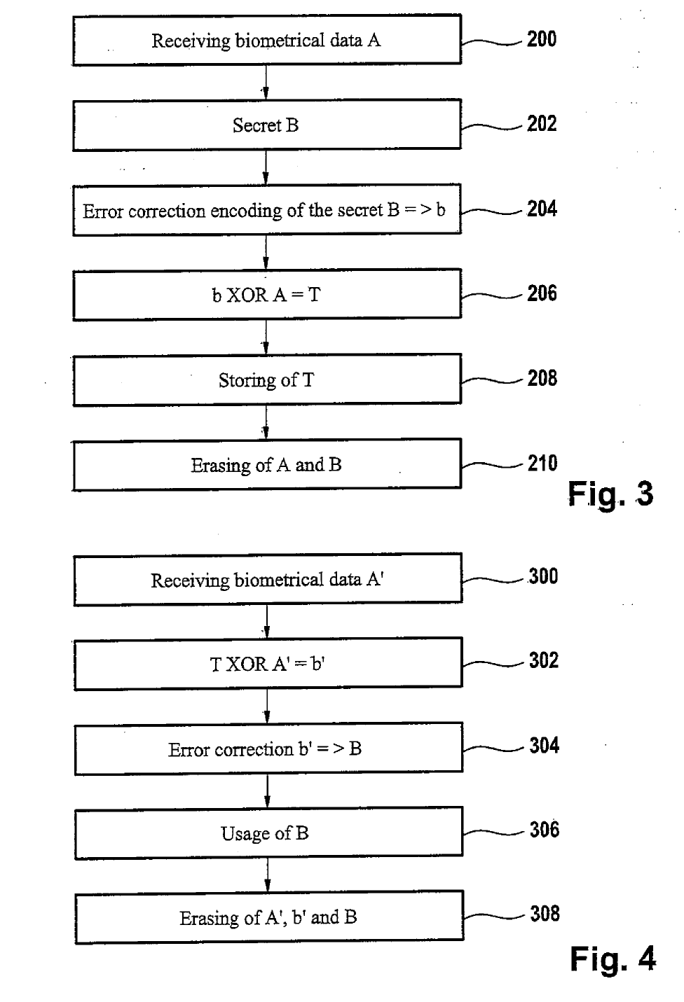

FIG. 4 illustrates the operation for recovering the secret B from the template T. In step 300 second biometrical data A′ is received as a result of biometric data acquisition of the biometrical feature of the person from which the original biometrical data A had been acquired. In step 302 an XOR operation is performed on the template T and the biometrical data A′ which provides the error correction encoded codeword b′ that may contain errors if A′ is not identical to A. In step 304 b′ is corrected using error correction decoding which provides the correct secret B. In step 306 B can then be used for performing a cryptographic operation. A′, b′ and B are erased in step 308.

In accordance with an embodiment of the invention, the hash value of the secret B is input into the security token, such as via its interface 111, in step 300 in addition to the biometrical data A′. The received hash value is compared with the hash value stored in the non-volatile memory of the security token. Only if the received hash value and the stored hash value are matching the following steps 302 to 308 are executed and a result of the usage of B is returned by the security token via its interface. Otherwise no result is returned.

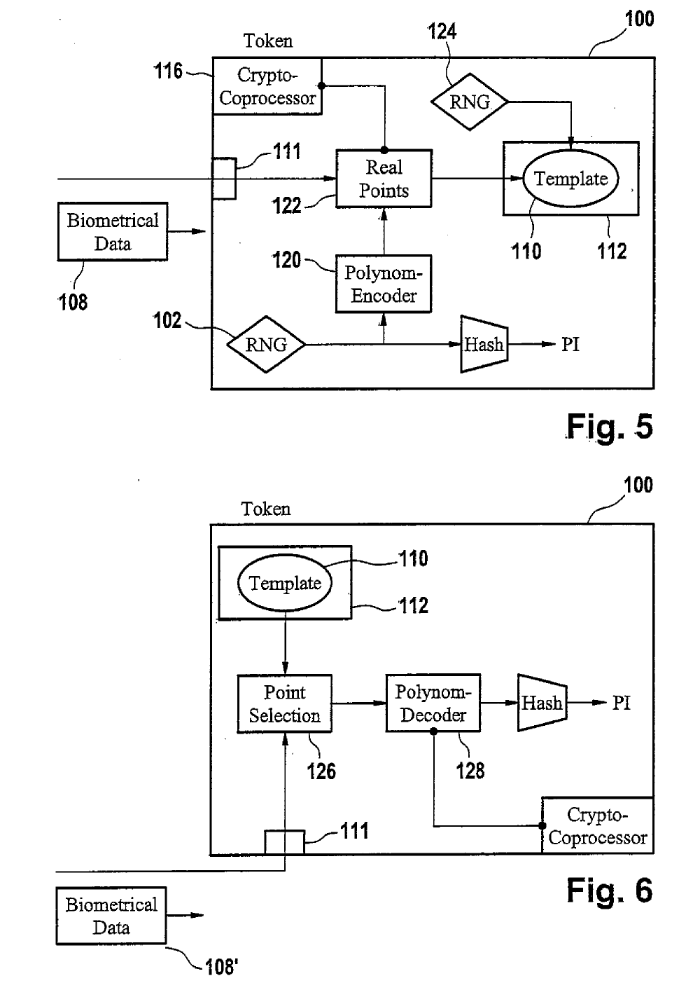

FIG. 5 shows a block diagram of an alternative embodiment of the security token 100. In contrast to the embodiments of FIGS. 1 and 2 a polynom p is used for the encoding. The random number generator 102 delivers a random number, i.e. the secret B, having a number of k digits b₀, b₁, bₖ₋₁. Alternatively the secret can be received via the communication interface 111. The security token 100 has a polynom encoder 120 that uses the k digits of the secret B to determine the coefficients of the polynom p, i.e.

p(x)=b₀+b₁x+b₂x²+b₃x³+ . . . +bₖ₋₁x^{k-1}

The security token further comprises a calculation module 122 that serves for calculation of the real points that are located on the polynom p. The real points are calculated by the calculation module 122 using the biometrical data 108 that comprises t values. The polynom is evaluated at each of the t values to provide the real points Pᵢ, where 021 i≦t. This provides the set of real points containing points P₁=(x₁, p (x₁)), P₂=(x₂, p (x₂)), . . . , Pₜ=(xₜ, p (xₜ)).

In addition a number of r−t randomly selected stray points are provided by a random number generator 124. The set of real points provided by the calculation module 122 and the set of stray points provided by the random number generator 124 in combination constitute the template 110 containing a number of r points.

It is to be noted that the polynom encoder 120, the calculation module 122, the random number generator 124, the point selection module 126 and/or the polynom decoder 128 can be implemented by dedicated logic circuitry or by a processor of the security token 100, such as by the crypto coprocessor 116, executing respective program modules.

FIG. 6 shows the security token 100 of FIG. 5 illustrating the decryption operation.

The security token 100 has a point selection module 126 for selection of real points from the template 110 and providing the identified real points to a polynom decoder 128 of the security token 100.

The selection of real points from the template 110 is performed by the point selection module 126 using the biometrical data 108′. The selection of a real point can be performed using a value contained in the biometrical data 108′ and searching for a point contained in the template 110 that has a matching or closely matching x-coordinate. If such a point can be identified, this point is considered a real point. This selection process is performed for each one of the values contained in the biometrical data 108′ and the resultant identified real points are provided to the polynom decoder 128 that reconstructs the polynom b from the real points delivered from the point selection module 126. As the coefficients of the polynom p constitute the secret B the polynom decoder 128 thus provides the secret B.

The polynom decoder 128 may implement Reed Solomon decoding such that even if some of the real points identified by the point selection module 126 are in fact stray points the polynom p may still be correctly decoded.

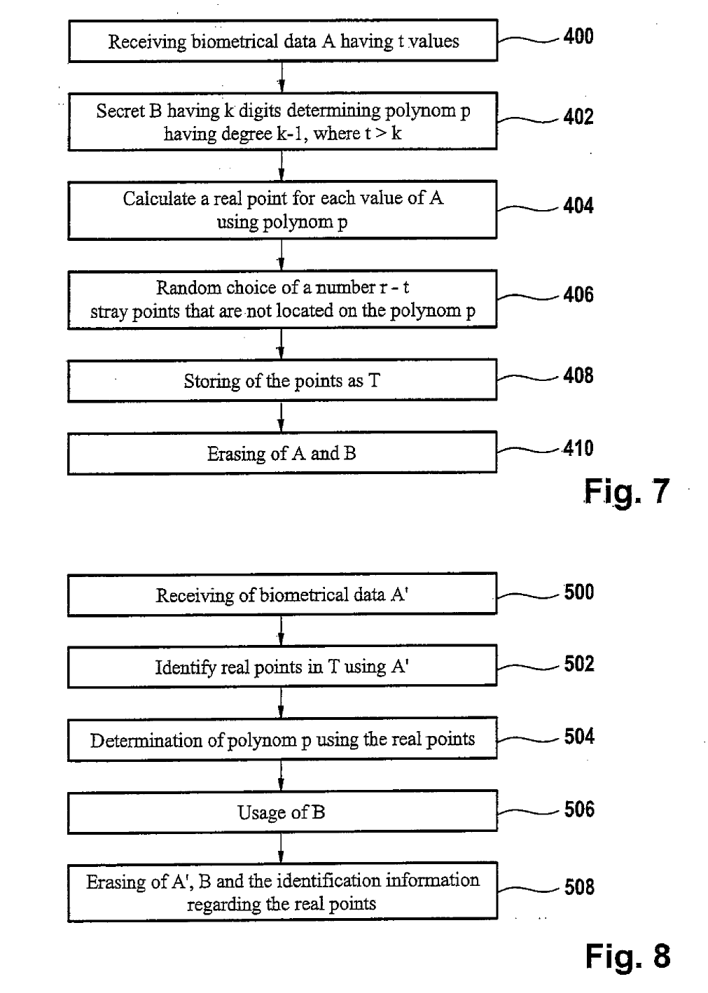

FIG. 7 illustrates a respective method of assigning the secret B to the security token using polynom encoding. In step 400 the biometrical data A having a number of t values is received by the security token. In step 402 the secret B having k digits is received or determined by the security token thus determining the polynom p having degree k−1, where t is greater than k for adding redundancy.

In step 404 a real point that is located on the polynom p is calculated for each value of A and in step 406 a number of r−t stray points that are not located on the polynom p are added to the set of real points providing a total of r points constituting the template T. The template T is stored in non-volatile memory of the security token in step 408 and the biometrical data A and the secret B are erased from the security token in step 410.

FIG. 8 illustrates the reverse operation: in step 500 the biometrical data A′ is received (cf. biometrical data 108′ of FIG. 6). In step 502 real points contained in T are identified using the values contained in the biometrical data A′. This is performed by searching T for the presence of a point that has a matching or closely matching x-coordinate to a value contained in A′. As a result of step 502 points are identified that are in fact real points being located on the polynom p. Depending on the implementation one or more stray points may wrongly be identified as being real points in step 502; this may occur if a stray point by chance has an x-coordinate that is matching or closely matching a value of A′.

In step 504 the polynom p is reconstructed using the real points that have been identified in step 502. Depending on the implementation the reconstruction of the polynom p is even possible if the points identified in step 502 also contain some stray points, in particular if the reconstruction of the polynom p is performed by means of Reed Solomon decoding.

In step 506 the secret B can be used for performing a cryptographic operation and in step 508 the critical data such as A′, B and identification information obtained in step 502 regarding the real points is erased in step 508 from the security token.

Analogous to the embodiments of FIGS. 3 and 4, a hash value of the secret B can be stored in the security token, such as in step 400, and the execution of steps 502 to 508 may be subject to receiving the correct hash value of the secret B, such as in step 500.

List of reference numerals

| | |
|---|---|
| 100 | Security token |
| 102 | Random number generator |
| 104 | Module |
| 106 | Logic component |
| 108 | Biometrical data |
| 108′ | Biometrical data |
| 110 | Template |
| 111 | Communication interface |
| 112 | Non-volatile memory |
| 114 | Logic component |
| 116 | Cryptographic coprocessor |
| 118 | Module |
| 120 | Polynom encoder |
| 122 | Calculation module |
| 124 | Random number generator |
| 126 | Point selection module |
| 128 | Polynom decoder |

What is claimed is:

1. A method of assigning a secret to a security token comprising:
receiving a first set of biometrical data of a biometrical feature of a person by the security token,
storing the first set of biometrical data in the security token,
storing the unencrypted secret in the security token,
biometrically encrypting the secret using the first set of biometrical data by the security token,
storing the encrypted secret in the security token,
erasing the unencrypted secret and the first set of biometrical data from the security token,
generating a hash value of the unencrypted secret by the security token and outputting of the hash value.

2. The method of claim 1, wherein the first set of biometrical data and/or the secret is stored in a volatile memory of the security token.

3. The method of claim 1, wherein the secret is generated by the security token.

4. The method of claim 1, wherein the security token is a USB stick, a chip card, in particular a smart card, a SIM card, in particular a USIM card, or an ID document.

5. The method of claim 1, wherein the step of biometrically encrypting the secret is performed by error correction encoding of the unencrypted secret and performing an XOR operation on the error correction encoded secret and the first set of biometrical data to provide the biometrically encrypted secret.

6. The method of claim 1, wherein the first set of biometrical data has a first number (t) of values and the secret has a second number (k) of digits determining the coefficients of a polynom (p), wherein the first number is greater than the second number, wherein the step of biometrically encrypting the secret is performed by calculating a real point for each value of the first set of biometrical data using the polynom, and providing random stray points that are not located on the polynom, wherein a union set of the set of real points and the set of random stray points provides the biometrically encrypted secret, and further comprising erasing the real points and the random stray points from the security token.

7. A method of operating a security token for performing a cryptographic operation, the security token having assigned thereto a secret, the method of operating the security token comprising:
receiving a second set of biometrical data of the biometrical feature of the person and a pseudo identity by the security token,
storing the second set of biometrical data in the security token,
reading the biometrically encrypted secret from a memory of the security token,
biometrically decrypting the secret using the second set of biometrical data by the security token,
comparing the pseudo identity with a hash value of the secret,
using the secret for performing the cryptographic operation in case the pseudo identity is identical with the hash value of the secret,
erasing the decrypted secret and the second set of biometrical data.

8. The method of claim 7, wherein the secret is used as a key for performing the cryptographic operation.

9. The method of claim 7, wherein biometrically decrypting the secret is performed by performing an XOR operation on the encrypted secret and the second set of biometrical data providing an incorrect secret, error correcting the incorrect secret using an error correction code which provides a corrected secret, and further comprising erasing the incorrect secret.

10. The method of claim 7, wherein the security token has assigned thereto a secret in accordance with claim 6, wherein biometrically decrypting the secret is performed by identifying at least a subset of the real points contained in the encrypted secret using the second set of biometrical data, determining the polynom using the real points which provides the secret, and further comprising erasing identification information that is indicative of the identified real points from the security token.

11. A storage medium which is readable by a processor of a security token, the storage medium containing instructions that when executed by the processor of the security token cause the security token to perform a method in accordance with claim 1.

12. A security token comprising:
an acquiring component capable of acquiring biometrical data,
a volatile storage component capable of temporarily storing the biometrical data and an unencrypted secret,
an encrypting component capable of biometrically encrypting the unencrypted secret using the biometrical data acquired by the acquiring component,
a non-volatile storage component capable of storing the biometrically encrypted secret,
a generating component capable of generating a hash value of the unencrypted secret by the security token and outputting the hash value, wherein the biometrical data is acquired from a biometrical feature of a person.

13. The security token of claim 12, further comprising:
a reading component capable of reading the encrypted secret from the non-volatile storage component,
a decrypting component capable of biometrically decrypting the encrypted secret using the biometrical data.
